(19) United States
(12) Patent Application Publication
(10) Pub. No.: US 2006/0287927 A1
(43) Pub. Date: Dec. 21, 2006

(54) Method and system for providing network support for management of household consumables

(75) Inventors: Sandra Lynn True, St. Charles, IL (US); David S. Benco, Winfield, IL (US); Sanjeev Mahajan, Naperville, IL (US); Baoling S. Sheen, Naperville, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/140,872

(22) Filed: May 31, 2005

(51) Int. Cl. G06Q 30/00

(52) U.S. Cl. 705/26

(57) ABSTRACT

A method and apparatus for providing network support for management of household consumables are provided. A modified network system utilizes a scanner-enabled wireless mobile device and a product database (e.g. a national product database) to provide consumers with a convenient manner in which to manage an inventory of household consumable items. In one form, such items can be added and deleted from the inventory by scanning UPC labels for the item. In addition, in one form, a shopping list is generated by comparison of a current inventory list with a desired inventory list.

### BACKGROUND OF THE INVENTION

This invention relates to a method and apparatus for providing network support for management of household consumables. More particularly, the invention is directed to a modified network system that utilizes a scanner-enabled wireless mobile device and a product database (e.g. a national product database) to provide consumers with a convenient manner in which to manage an inventory of household consumable items. In one form, such items can be added and deleted from the inventory by scanning UPC labels for the item. In addition, in one form, a shopping list is generated by comparison of a current inventory list with a desired inventory list.

While the invention is particularly directed to the art of managing an inventory of household consumables, and will be thus described with specific reference thereto, it will be appreciated that the invention may have usefulness in other fields and applications. For example, the teachings of the present invention may be used in other applications where managing an inventory through use of a wireless network is desired.

By way of background, the typical consumer uses a shopping list to make the shopping experience more efficient. This shopping list is usually compiled manually by physically listing needed items on a sheet of paper after a perusal of the consumable storage areas of the residence. Of course, there are many disadvantages to such a practice. There is no guarantee that the perusal will encompass all areas of storage. Also, at the time of taking inventory, one may not have a firm idea of a desired amount of any given item. Of course, this could easily occur where more than one member of the household is responsible for shopping. As such, this manual system does not assure any consistency in inventory of items. Moreover, this manual task of generating a shopping list is time-consuming.

In addition, variations in the implementations of wireless phones are ever-increasing. Recently, the use and public knowledge of scanner enabled mobile phones has become increasingly well known. For example, U.S. Publication No. 2005/0091124 A1 discloses a product purchase and decision making device, U.S. Publication No. 2004/0204120 A1 discloses a portable telephone having a scanning device and U.S. Pat. No. 6,002,946 to Reber et al. discloses a handheld device having an optical data reader. In addition, other types of handheld devices including integrated data readers are known. These devices may be of a wand form, gun form, or handheld computer form.

The present invention contemplates a new and improved inventory management system for household consumables that resolves the above-referenced difficulties and others.

### SUMMARY OF THE INVENTION

A method and apparatus for managing an inventory of consumable items are provided.

In one aspect of the invention, the method comprises maintaining a list of on-hand quantities of the consumable items for a subscriber, maintaining a product database having product information stored therein on various consumable items, receiving a request to update the list from the subscriber, receiving data relating to scanned codes of the consumable items, querying the product database based on the scanned codes, retrieving selected product information based on the scanned codes and updating the list based on the request and the selected product information.

In another aspect of the invention, the receiving of the request to update is a request to add at least one item to the list and the updating comprises adding the at least one item to the list.

In another aspect of the invention, the receiving of the request to update is a request to delete at least one item from the list and the updating comprises deleting the at least one item from the list.

In another aspect of the invention, the method further comprises recognizing the data relating to the scanned codes as scan data.

In another aspect of the invention, the method further comprises determining whether the subscriber is a valid subscriber.

In another aspect of the invention, the method further comprises maintaining a second list of desired quantities of the consumable items and calculating a third list based on the first list and the second list.

In another aspect of the invention, the method further comprises downloading the third list to the subscriber.

In another aspect of the invention, the system comprises means for maintaining a list of on-hand quantities of the consumable items for a subscriber, means for maintaining a product database having product information stored therein on various consumable items, means for receiving a request to update the list from the subscriber, means for receiving data relating to scanned codes of the consumable items, means for querying the product database based on the scanned codes, means for retrieving selected product information based on the scanned codes and means for updating the list based on the request and the selected product information.

In another aspect of the invention, the request to update is a request to add at least one item to the list and the means for updating comprises means for adding the at least one item to the list.

In another aspect of the invention, the request to update is a request to delete at least one item from the list and the means for updating comprises means for deleting the at least one item from the list.

In another aspect of the invention, the system further comprises means for recognizing the data relating to the scanned codes as scan data.

In another aspect of the invention, the system further comprises means for determining whether the subscriber is a valid subscriber.

In another aspect of the invention, the system further comprises means for maintaining a second list of desired quantities of the consumable items and means for calculating a third list based on the first list and the second list.

In another aspect of the invention, the system further comprises means for downloading the third list to the subscriber.

In another aspect of the invention, the system comprises a first database having stored therein a list of on-hand quantities of the consumable items for a subscriber, a second database having product information stored therein on various consumable items and a switching module operative to receive a request to update the list from the subscriber, receive data relating to scanned codes of the consumable items, query the product database based on the scanned codes, retrieve selected product information based on the scanned codes and update the list based on the request and the selected product information.

In another aspect of the invention, the request to update is a request to add at least one item to the list and the switching module is operative to add the at least one item to the list.

In another aspect of the invention, the request to update is a request to delete at least one item from the list and the switching module is operative to delete the at least one item from the list.

In another aspect of the invention, the switching module is operative to recognize the data relating to the scanned codes as scan data.

In another aspect of the invention, the switching module is operative to determine whether the subscriber is a valid subscriber.

In another aspect of the invention, the first database has stored therein a second list of desired quantities of the consumable items and the switching module is operative to calculate a third list based on the first list and the second list.

In another aspect of the invention, the switching module is operative to download the third list to the subscriber.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a representative view of a network into which the present invention is implemented;

FIG. 2 is a representative view of a switching module according to the present invention;

FIG. 3 is a representative view of a database module according to the present invention;

FIG. 4 is a representative view of a database module according to the present invention;

FIG. 5 is a flowchart illustrating a method according to the present invention; and,

FIG. 6 is a flowchart illustrating a method according to the present invention.

### DETAILED DESCRIPTION OF THE PREFERRED EMBODIMENTS

According to embodiments of the present invention, the telecommunications network and an enhanced mobile device are combined to achieve advantages in the management of inventory of household consumables. Implementation of the invention, in at least one form, involves the use of an enhanced mobile device, such as scanner enabled mobile device with a suitable user interface, to allow for the entry and maintenance of inventory items (e.g. household consumables). For example, a subscriber could establish a desired list of items that the subscriber would always like to have available (e.g. 2 bottles of ketchup, 6 rolls of toilet paper, . . . etc.). This task could be completed once. Then, during the weekly shopping trip, when an item is purchased, the bar code for the item is scanned using the scanner enabled mobile device. This date is maintained (or added) in the system as an on-hand list of consumables. Of course, a user may also begin the overall process by logging in a current, initial inventory. Prior to items being discarded when they are consumed, the UPC label or bar code is again scanned. This is designated as a deleted item and subtracts from the on-hand list. When it is time for the next weekly shopping trip, a soft key (for example) could be activated to calculate and download a grocery list based on the on-hand list and a desired items list. Once established, this process could be self sustaining.

In this regard, the invention provides a variety of advantageous techniques. It provides a methodology for a mobile subscriber to define a custom household consumables list for use by way of a menu interface on the mobile handset and subsequent storage of that list in the telecommunications network. The present techniques also allow for scanning of UPC labels by a mobile handset with the appropriate scanning functionality. This data is forwarded on to the network to initiate a query to a product database to retrieve product data and information. These techniques provide the subscriber with the ability to process requests to add or subtract from the inventory lists. Notably, the techniques also provide the ability to calculate a shopping list based on the noted lists and download that calculated list to the subscriber.

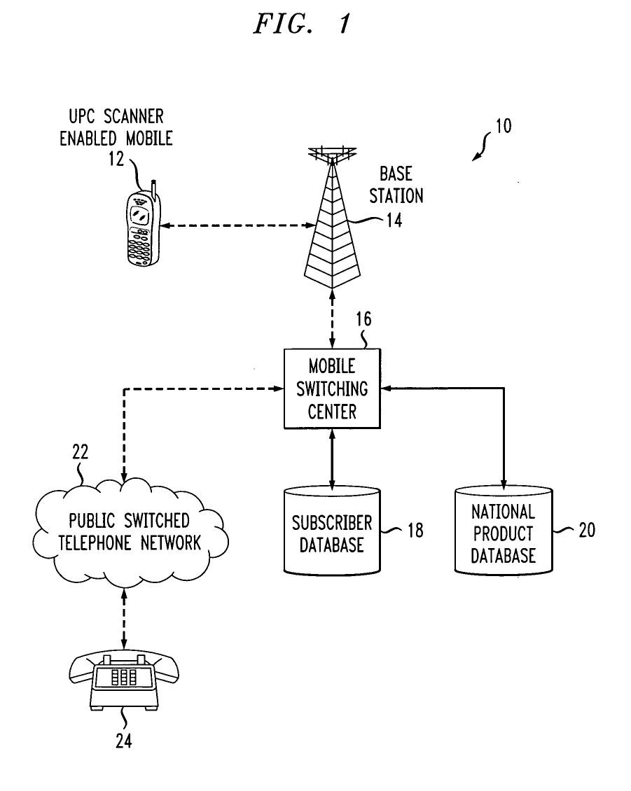

Referring now to the drawings wherein the showings are for purposes of illustrating the preferred embodiments of the invention only and not for purposes of limiting same, FIG. 1 provides a view of an example network into which the present invention may be implemented. As shown, a network 10 communicates with a mobile device 12 through a base station 14. The mobile device 12 may take a variety of forms; however, in at least one form according to the present invention, the mobile device 12 is a scanner enabled mobile device, such as one of those described above. It may also take the form of a mobile device and scanner combination whose elements that, while not integrated with one another, cooperate to achieve similar objectives as an integrated mobile device and scanner. Moreover, the mobile device 12 will preferably have a suitable interface to allow for implementation of the present invention. Such an interface is, in one form, capable of receiving input from a subscriber on the noted lists of items. In addition, the interface may well have a soft key(s) disposed thereon to accommodate other functions, such as requesting updating of any of the stored lists or requesting calculation and download of a shopping list based on the other stored lists.

The base station 14 may take any of a number of forms that are well known in the art. It should also be appreciated that the base station 14 may take on an entirely different form as a function of the generation of technology employed in the network 10.

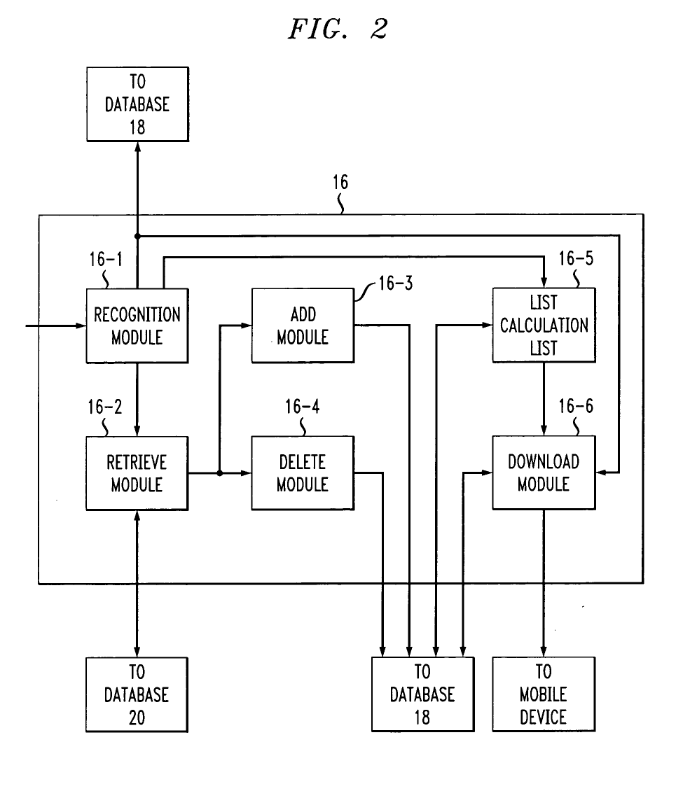

The network 10 also includes a switching module taking an exemplary form of a mobile switching center 16. The mobile switching center 16 may be of a variety of configurations, provided it includes the functionality that will be later described in connection with FIG. 2. Nonetheless, it should be understood that the mobile switching center 16 will also have a variety of components and functionality that will not be described herein but are well known in the art. Like the base station 14, the mobile switching center 16 may take on a different form (e.g. as a different type of switching module) as a function of the generation of technology employed in the network 10. In this regard, the invention may be implemented utilizing any type of primary switching module in a network.

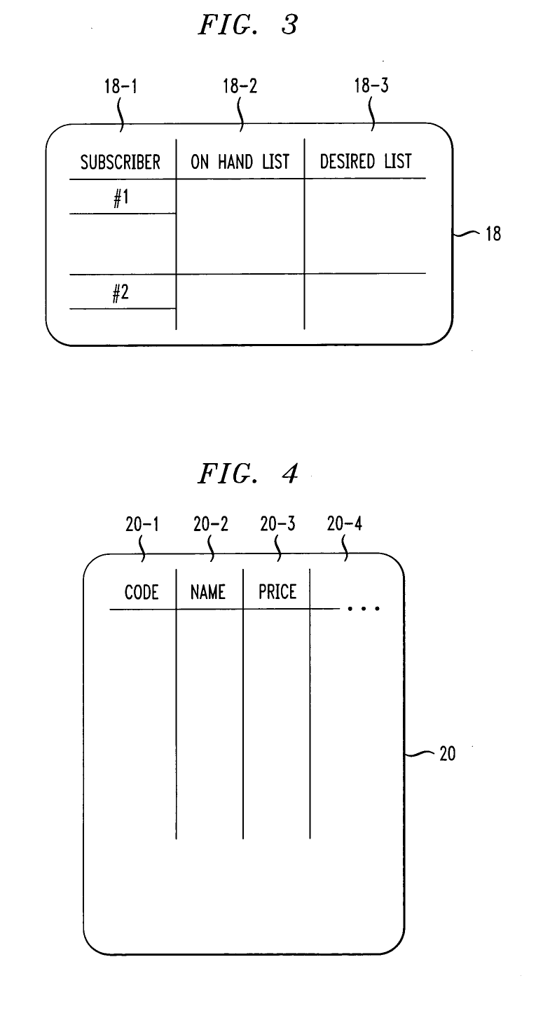

The mobile switching center 16 communicates with a subscriber database 18 and a product database (e.g. national product database) 20. The subscriber database 18 may take a variety of forms, one of which will be described in connection with FIG. 3. The product database 20 may likewise take on any of a variety of forms, one of which will be described in connection with FIG. 4, but will, at least in one form, comprise data (such as bar code data or UPC data) that is available for retail products on a national level.

Also, by way of example, the mobile switching center 16 may communicate with a variety of network elements including the public switched telephone network (PSTN) 22. The public switched telephone network (PSTN) 22 connects to a landline phone 24.

Referring now to FIG. 2, an exemplary form of the mobile switching center 16 is depicted. As shown, the mobile switching center 16 includes a recognition module 16-1. The recognition module 16-1 is operative to recognize scanned data as a particular type that is useful for implementation of the present invention. For example, the recognition module 16-1 may recognize UPC or bar code data that may be transmitted from a scanner-enabled mobile device, such as mobile device 12. The recognition module is also operative to accomplish a number of other tasks. For example, the recognition module 16-1 is operative to validate subscribers by accessing the subscriber database when necessary. Moreover, the recognition module 16-1 is operative to receive requests from the subscribers, such as a request to add items to inventory lists, a request to delete items from an inventory list, or a request to establish a new or modified desired inventory list. In addition, the recognition module is operative to recognize a request to calculate a shopping list as will be accomplished by the list calculation module 16-5 below. The mobile switching center 16 also includes a retrieve module 16-2. This module is operative to retrieve product information from the product database 20 corresponding to the UPC or bar code data that is recognized by the recognition module 16-1.

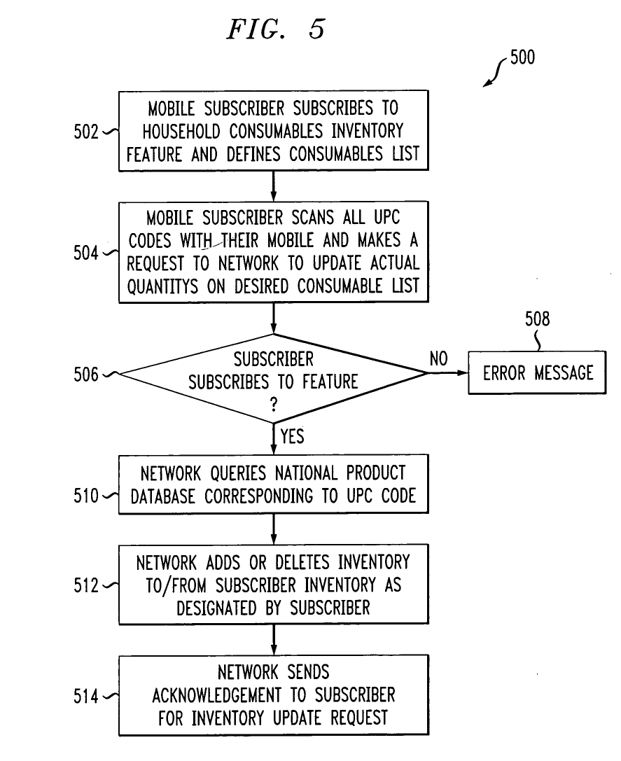

The mobile switching center 16 further includes an add module 16-3 and a delete module 164. These modules, in one form, are responsive to process the data retrieved or translated by the retrieve module. As will be described in more detail in connection with FIG. 5, these modules enable the system to add and delete items from inventory lists that are stored on behalf of the subscriber.

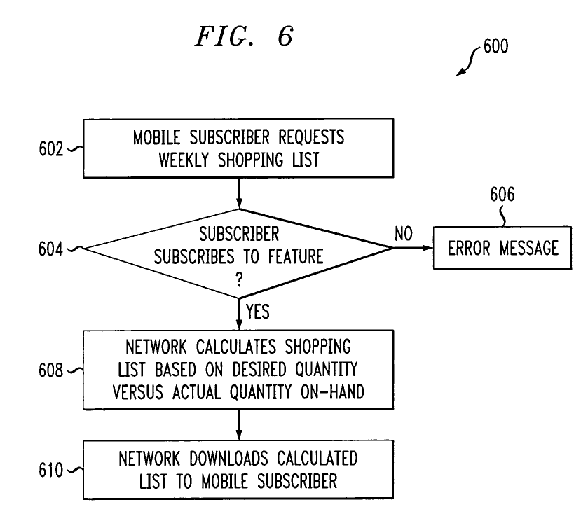

Also illustrated is a list calculation module 16-5 which is operative to calculate a shopping list by comparing an on-hand list with a desired list, as will be described in connection with FIG. 3 and FIG. 6. Suitable routines may be implemented to accomplish this task in the list calculation module 16-5. In one form of the calculation module 16-5, a simple comparison between quantity values of the respective lists stored in the database 18 may be accomplished to determine the quantities that should be included on the calculated list, or the shopping list. A download module 16-6 is also implemented to perform download functions for the calculated shopping lists. In one form, this downloading typically comprises downloading of data from the mobile switching center 16 to the interface of the mobile device 12 so that the subscriber may view the calculated shopping list. Other types of data may also be downloaded. For example, there may be an advantage to download the on-hand list or the desired list at various times.

Referring to FIG. 3, an exemplary form of the subscriber database 18 is illustrated. This database may have a variety of fields incorporated therein that are not specifically described herein but will be apparent to those of skill in the art. For example, a status field may be used to indicate whether the subscription is active. Notably, however, to implement the present invention, the example database 18 includes a subscriber field 18-1 having contained therein information on the identity of subscribers to the inventory management service contemplated herein. Also included within the database are an on-hand list field 18-2 and a desired list field 18-3. The on-hand list field 18-2 includes data representing the running inventory of consumable items for any given subscriber. This field is incremented or decremented by the add module 16-3 and delete module 16-4, respectively, during implementation of the method according to FIG. 5. The desired list field 18-3 includes data representing a desired inventory of the subscriber. The subscriber may initialize his/her subscription by inputting this list to the system through the interface provided to the mobile device. Both of these fields 18-2 and 18-3 are also accessed and used by the list calculation module 16-5 during the calculation of shopping lists according to the method as set forth in FIG. 6, for example.

Referring now to FIG. 4, an exemplary form of the product database 20 is illustrated. As noted above, in one form, this database includes information on retail products and is available on a nationwide basis, for convenience. Implementation of such a national product database will be apparent to those in the database management and/or field. As shown, this database includes a code field 20-1, having stored therein data on the various bar codes and/or UPC codes that may be scanned. The remaining data fields of this database have data stored therein corresponding to the various code data listed. For example, a name field 20-2 includes product names corresponding to the code data. Further, a price field 20-3 may be included. Other fields represented by the reference numeral 20-4 may also be incorporated in the database. The content of these fields depends on the objectives of the designer. This database may take a variety of forms and may be populated by any means available to, for example, the retail industry. As shown, the fields of the databases 18 and 20 are not populated; however, this is for ease of reference only. It will be appreciated that data of any of a variety of formats may be used to populate these fields.

The components described in connection with FIGS. 1-4 operate in a variety of manners to implement the embodiments of the present invention. For example, a valid subscriber to the inventory management features contemplated by the present invention is able to define a household consumable list of desired items using an appropriate interface of a mobile device. This desired list is then stored in the subscriber database 18. As the subscriber purchases items, e.g. adds them to a shopping cart, or consumes items, the mobile subscriber scans the UPC code of the selected items using a scanner enable mobile device. The code is locally stored on the mobile device until it is forwarded to the network for processing. At the network, a national product database is queried to translate the UPC code to an actual product name or the like. The product quantity can then be suitable added or subtracted from an appropriate on-hand list. Last, before the next weekly shopping trip, the mobile subscriber need simply press a soft key or the like and a shopping list is calculated based on the desired item list and the on-hand, or actual quantity, list. This calculated may then be downloaded to the mobile device.

Along these lines, referring to FIG. 5, a method 500 for establishing the appropriate lists and adding and subtracting inventory is illustrated. Initially, a mobile subscriber subscribes to the household consumables inventory feature and defines a desired shopping or inventory list (at 502). This may be accomplished in a number of ways such as through an interface of the mobile device 12. In this case, the list could be keyed into the system. For convenience, other techniques, such as internet and website techniques, may be used to reduce the difficulty of keying in large amounts of text to establish this list. This list is then stored in the subscriber database. Next, a mobile subscriber may scan UPC or bar codes on items to be added to or deleted from the on-hand list. In doing so, the subscriber makes a request to update the on-hand list (at 504). The system, of course, must verify that the subscriber is valid (at 506). In this regard, the subscriber database 18 may be accessed to determine the status of the subscriber. A status field may be incorporated in the database or the presence or absence of the subscriber identity in the database may be sufficient to demonstrate status. The recognition of bar code data and verification of subscriber identity and validity is implemented by the recognition module 16-1 of the mobile switching center 16, in one form. If the subscriber is not valid, an error message is sent (at 508). However, if the subscriber is valid, the retrieve module 16-2 queries the product database 20 to locate the entry for the scanned bar code data (at 510). The add module 16-3 or the delete module 164 is then initiated to add or delete data based on the retrieved product data (at 512). Of course, the switching module may also send an acknowledgement to the subscriber (at 514).

With reference now to FIG. 6, a method 600 for calculating a shopping list is illustrated. Initially, the subscriber may request a weekly shopping list (at 602). Next, a determination is made by the recognition module 16-1 as to whether the subscriber is a valid subscriber (at 604). Of course, the subscriber database may be accessed to do so. If the subscriber is not valid, an error message is transmitted (at 606). If the subscriber is, valid, the list calculation module 16-5 accesses the subscriber database to calculate the shopping list based on the on-hand list field 18-2 and the desired list field 18-3 (at 608). To do so, a simple comparison of quantities will typically suffice. The nature of the manner in which the data is stored will dictate the ultimate calculation method, which will be apparent to those skilled in the art of database processing and management. The download module 16-6 then performs download operations, as those of skill in the art will appreciate (at 610).

It should be understood that the methods described in connection with FIGS. 5 and 6, as well as other methods contemplated by the present invention, may be implemented in a variety of manners. For example, the switching module (e.g. mobile switching center 16) may be configured to accommodate suitable hardware configurations and software routines reflecting such methods. An example of such a configuration is illustrated in FIG. 2. The software may also be distributed throughout appropriate network elements, such as the database modules and/or the mobile device. Of course, the software may also be centralized and simply downloaded to other elements, if desired.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method for managing an inventory of consumable items, the method comprising:
maintaining a list of on-hand quantities of the consumable items for a subscriber;
maintaining a product database having product information stored therein on various consumable items;
receiving a request to update the list from the subscriber;
receiving data relating to scanned codes of the consumable items;
querying the product database based on the scanned codes;
retrieving selected product information based on the scanned codes; and,
updating the list based on the request and the selected product information.

2. The method as set forth in claim 1 wherein the receiving of the request to update is a request to add at least one item to the list and further wherein the updating comprises adding the at least one item to the list.

3. The method as set forth in claim 1 wherein the receiving of the request to update is a request to delete at least one item from the list and further wherein the updating comprises deleting the at least one item from the list.

4. The method as set forth in claim 1 further comprising recognizing the data relating to the scanned codes as scan data.

5. The method as set forth in claim 1 further comprising determining whether the subscriber is a valid subscriber.

6. The method as set forth in claim 1 further comprising:
maintaining a second list of desired quantities of the consumable items; and,
calculating a third list based on the first list and the second list.

7. The method as set forth in claim 6 further comprising downloading the third list to the subscriber.

8. A system for managing an inventory of consumable items, the system comprising:
means for maintaining a list of on-hand quantities of the consumable items for a subscriber;
means for maintaining a product database having product information stored therein on various consumable items;
means for receiving a request to update the list from the subscriber;
means for receiving data relating to scanned codes of the consumable items;
means for querying the product database based on the scanned codes;
means for retrieving selected product information based on the scanned codes; and,
means for updating the list based on the request and the selected product information.

9. The system as set forth in claim 8 wherein the request to update is a request to add at least one item to the list and further wherein the means for updating comprises means for adding the at least one item to the list.

10. The system as set forth in claim 8 wherein the request to update is a request to delete at least one item from the list and further wherein the means for updating comprises means for deleting the at least one item from the list.

11. The system as set forth in claim 8 further comprising means for recognizing the data relating to the scanned codes as scan data.

12. The system as set forth in claim 8 further comprising means for determining whether the subscriber is a valid subscriber.

13. The system as set forth in claim 8 further comprising:
means for maintaining a second list of desired quantities of the consumable items; and,
means for calculating a third list based on the first list and the second list.

14. The system as set forth in claim 13 further comprising means for downloading the third list to the subscriber.

15. A system for managing an inventory of consumable items, the system comprising:
a first database having stored therein a list of on-hand quantities of the consumable items for a subscriber;
a second database having product information stored therein on various consumable items; and
a switching module operative to receive a request to update the list from the subscriber, receive data relating to scanned codes of the consumable items, query the product database based on the scanned codes, retrieve selected product information based on the scanned codes and update the list based on the request and the selected product information.

16. The system as set forth in claim 15 wherein the request to update is a request to add at least one item to the list and further wherein the switching module is operative to add the at least one item to the list.

17. The system as set forth in claim 15 wherein the request to update is a request to delete at least one item from the list and further wherein the switching module is operative to delete the at least one item from the list.

18. The system as set forth in claim 15 wherein the switching module is operative to recognize the data relating to the scanned codes as scan data.

19. The system as set forth in claim 15 wherein the switching module is operative to determine whether the subscriber is a valid subscriber.

20. The system as set forth in claim 15 wherein the first database has stored therein a second list of desired quantities of the consumable items and further wherein the switching module is operative to calculate a third list based on the first list and the second list.

21. The system as set forth in claim 20 wherein the switching module is operative to download the third list to the subscriber.
